(19) United States
(12) Patent Application Publication
(10) Pub. No.: US 2012/0017614 A1
(43) Pub. Date: Jan. 26, 2012

(54) Apparatus and Method of Using Nanofluids to Improve Energy Efficiency of Vapor Compression Systems

(76) Inventor: Edward Vincent Clancy, (US)

(21) Appl. No.: 12/841,089

(22) Filed: Jul. 21, 2010

(51) Int. Cl. C09K 5/00; F25B 1/00

(52) U.S. Cl. 62/114; 62/502

(57) ABSTRACT

Nanofluids for vapor compression systems is a new invention to enable vapor compression systems used in air conditioning and refrigeration systems to take advantage of nanoparticles. Prior work has already shown that using nanoparticles is an excellent method to improve heat transfer in water, ethylene glycol, and engine oil applications. This invention is a method and apparatus for using nanofluids that will increase the heat transfer in the condenser of vapor compression systems; thereby, reducing power consumption. The system uses nanoparticles in the condenser to increase heat transfer and reduce the condensing pressure thereby saving energy.

### STATEMENT REGARDING FEDERALLY SPONSORED RESEARCH OR DEVELOPMENT

Research was partially funded by the National Science Foundation's Small Business Research Grant, January 2010 Award Number IIP 0944681

### REFERENCE TO RELATED APPLICATIONS

None

### BACKGROUND OF THE INVENTION

The use of nanofluids (nano-refrigerants) for vapor compression systems is a new invention that enables vapor compression systems used air conditioning, and refrigeration systems to take advantage of nanoparticles. Prior work has already shown that using nanoparticles is an excellent method to improve heat transfer in water, ethylene glycol, and engine oil applications. This invention uses a nano-refrigerant system that will increase the heat transfer in the condenser of vapor compression systems; thereby reducing power consumption. The most common method to increasing the heat transfer rate in a cycle is to use extended heat transfer surfaces for exchanging heat with a heat transfer fluid. This approach produces an undesirable increase in the size of the heat exchange device. In addition, the inherent poor thermodynamic properties of conventional heat transfer fluids such as water, refrigerants, ethylene glycol or engine oil limit the amount of heat transfer. Therefore, there is a need to develop advanced cooling techniques and innovative heat transfer fluid with better heat transfer performance than those presently available.

It is well known that metallic solids possess order of magnitude higher thermal conductivity than conventional heat transfer fluids. For example the thermal conductivity of copper is 3000 times greater than engine oil. In the past, researchers have tried to increase the thermal conductivity of base fluids by suspending micro or large sized solid particles into the fluid, because the thermal conductivity of solids such as copper is so much higher than that of liquids. Prior researchers expected that the metallic particles would significantly increase the heat transfer. Unfortunately, when this has been tried, large size particles follow Maxwell's theory in that they lack stability and settle out of the liquid. The suspension also causes additional flow resistance and possible erosion problems which are negative effects of using a mixture of a base liquid with suspended large metallic particles.

Modern nanotechnology provides new opportunities to produce material with an average particle size below 100 nm (nanometer). These nanoparticles do not follow Maxwell's theory and have a much large relative surface area as compared to conventional particles. Unlike suspension discussed above, nanoparticles not only improve heat transfer, they also may reduce flow friction and can be made to remain in a stable suspension. Nanofluids are not new. In fact, human blood is an example of a mixture of suspended nanoparticles in a fluid.

It has been documented that the addition of nanoparticles has remarkably enhanced the heat transfer of the base liquid. These nanofluids are quite different from conventional two-phase flow mixtures discussed earlier. The inventor has been demonstrated that nanoparticles can improved heat transfer properties by 193% increase with only a 1.33 weight % added to the refrigerant. Nanofluids not only increase thermal conductivity they can also reduce flow friction because of the effects of slip velocity; thereby causing very little pressure drop in the heat exchanger. In addition, nanoparticles resist sedimentation, as compared to larger particles, due to Brownian motion and inter-particle forces.

The focus of the patent is on vapor compression cycles; yet, the proposed technique can also be used as a cost-effective method for improving absorption cooling, engine oil cooling, heat pipes, ground source heat pumps, water and glycol cooling systems as well.

A typical vapor compression system consists of a compressor, condenser, expansion valve or capillary tube and an evaporator. Currently, vapor compression systems have not been able to take advantage of the beneficial properties of nanoparticles because the nanoparticles can damage the compressor. Nanoparticles would also decrease the performance of the refrigerant in the evaporator of the cycle when the refrigerant is changing phases. This invention solves this problem by collecting nanoparticles with a membrane at the outlet of the condenser. This approach prevents nanoparticles from entering the evaporator and compressor. The collected nanoparticles are then returned to the inlet of the condenser by a novel membrane and recirculation system. There is a potential energy savings for a typical air conditioning and refrigeration system because of the increased heat transfer in the condenser; thereby causing a lower saturation temperature and pressure in the condenser. This results in lower energy cost.

Another embodiment is putting the nanoparticle into the lubricating oil of the system for small systems. In small HVAC and refrigeration systems lubricating oil circulates around the system. Nanoparticles in the lubricating oil would not harm the system because the evaporator is designed to drain back into the compressor. In large chiller water type systems, the compressor in a centrifugal type and no nanoparticles should be allowed to enter the compressor of a centrifugal type. An oil separator is located prior to the inlet of the compressor for some systems.

### BRIEF SUMMARY OF THE INVENTION

Nano-refrigerants allow nanoparticles to enter the condenser of an air condition or refrigeration system and improve the heat transfer of the base refrigerant. The system collects the nanoparticles at the outlet of the condenser and returns the nanoparticles to the inlet of the condenser.

A dispersant (surfactant) may be mixed with the nanoparticles and the refrigerant to help lower the surface tension of the refrigerant and improve the dispersion of the nanoparticles in the refrigerant. The nanoparticles may also be coated and no dispersant used. The goal is to produce a stable dispersion. The use of an acoustic agitator may be used but is not the preferred embodiment. The refrigerant is first mixed with the dispersant (surfactant) and then the nanoparticles are added to the mixture while in liquid form. A sonicator is used to break up the nanoparticles. A water or cooling bath is used to cool the refrigerant while sonicating the mixture and help maintain the refrigerant in liquid state. The cooling bath may use water, ethylene or propylene glycol, or liquid nitrogen to maintain the refrigerant in liquid state.

This invention uses a novel duplex membrane or filter arrangement that will collect the charged nanoparticles at the outlet of the condenser. One side of the membrane (filter) will be collecting the nanoparticles while the other section of the duplex membrane will undergo reverse flow through the membrane so that the nanoparticles can be returned to the inlet of the condenser. A directional valve can be used with three positions. In one direction the valve will bypass the membrane. In the other two positions of the valve the fluid will be directed to either side of the duplex membrane.

Charged surfactants (dispersants) can be used such as: Fluorinert™ manufactured by 3M and Krytox™ FSL manufactured by DuPont. In the preferred embodiment a coating was used in carbon nanotubes.

The nanoparticles may be either TiO₂, Al₂O₃, CuO, Fe₃O₄, carbon nanotubes, gold nanoparticles or a combination of the above nanoparticles. In the preferred embodiment the nanoparticles will be carbon nanotubes (CNT)—(SWCNT—single wall carbon nanotubes or MWCNT—multi-wall carbon nanotubes). The percent of nanoparticles will be less than 10% of the fluid weight percent. The nanoparticles size will be from 1 to 100 nm in size in diameter. A large aspect ratio (length of the CNT:diameter of the CNT) is preferred. Ranges of length are from 10 nm to 300 mm.

The membrane can be a flow through type in the preferred embodiment that has a charged surface so that the charged surfactant can be collected on the membrane. The charge of the membrane will be adjusted so that during the re-circulation the charged surfactant (dispersant) with nanoparticles will be returned to the inlet of the condenser. The membrane or filter does not require a charged surface. The size of the membrane ranges from a pore size of 10 nm to 1000 nm.

### BRIEF DESCRIPTION OF THE DRAWING

FIG. 1—Depicts the flow diagram for the system.

FIG. 2—Depicts the membrane collecting charged nanoparticles.

FIG. 3—Depicts the directional valve.

FIG. 4—Depicts a recirculation pump that can be used to circulate the nanofluids.

FIG. 5—Depicts the components of the system.

### DETAILED DESCRIPTION OF THE INVENTION

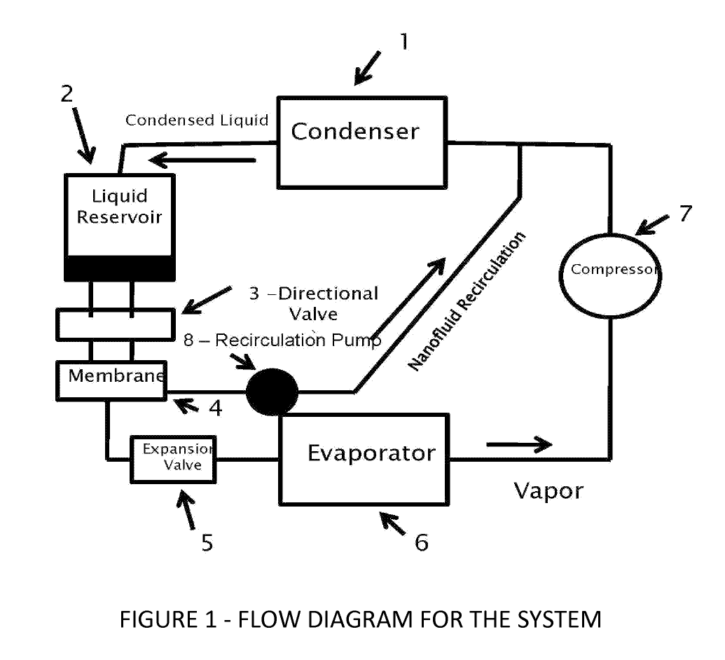

FIG. 1 illustrates that the refrigerant 7 is mixed with a nanofluids at the inlet of the condenser 1 of the system. The mixture leaves the condenser 1 and enters the liquid reservoir 2. Some smaller systems do not have a liquid reservoir. The mixture of refrigerant and nanofluids then enters a three position direction valve 3. The valve can be a two direction valve. In the three directional valve, the valve can be positioned such that the fluid can bypass the membrane, or send the fluid to membrane 4A or to membrane 4B. The membrane 4 is a duplex type membrane with one section of the membrane being re-circulated and the other section of the membrane collecting the nanoparticles on the charge of the membrane.

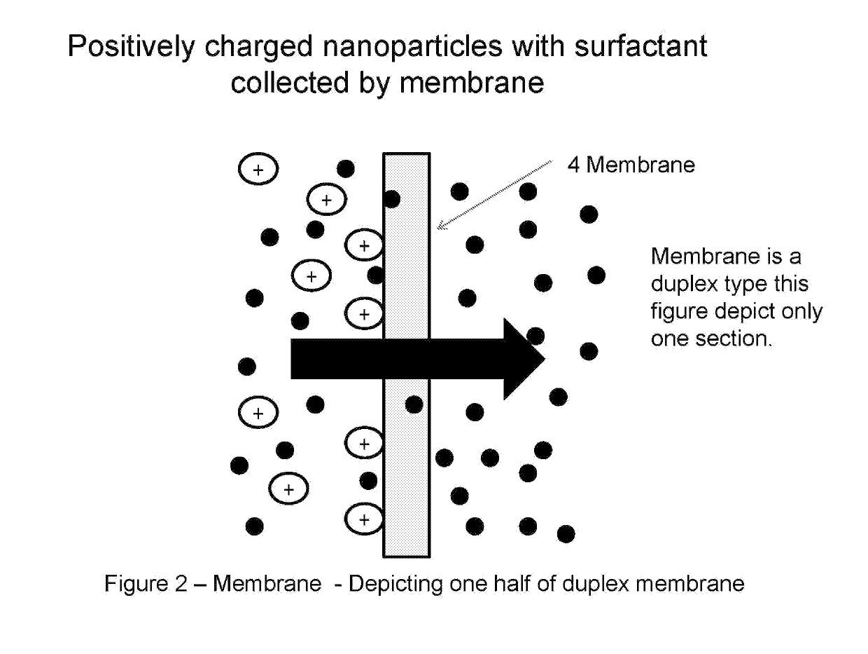

As depicted in FIG. 2, charged nanoparticles with surfactant are collected on the charged membrane 4. The membrane 4 is a duplex type where one section of the membrane 4A is being re-circulated while the other section of the membrane 4B is collecting the nanoparticles. After a period of time, the directional vale 3 is moved the flow is re-directed to the other section of the membrane. The re-circulated section 4A is now free of nanoparticles and is ready to received flow from the condenser 1 and the other section of the membrane 4B is ready for re-circulation. The nanoparticles are returned to the inlet side of the condenser.

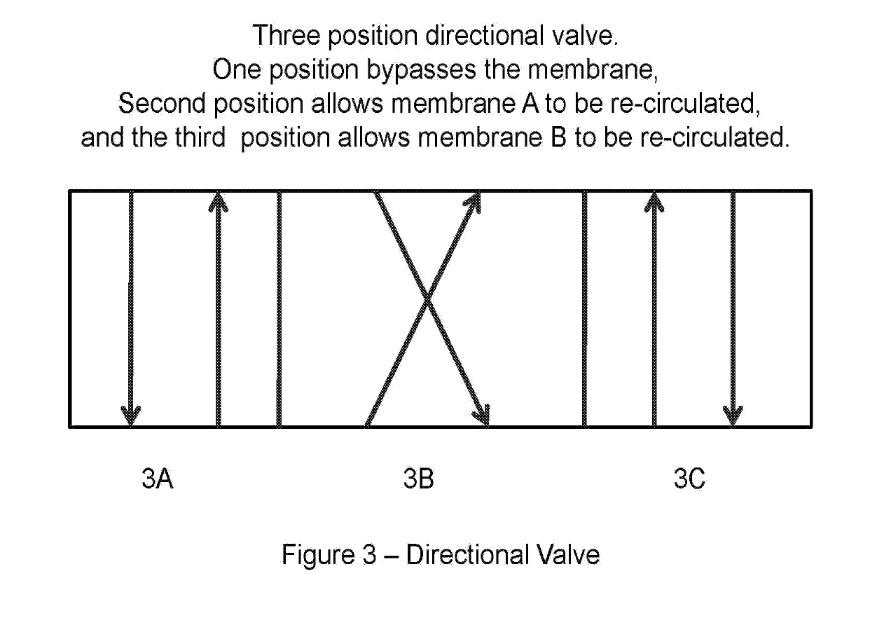

FIG. 3 details a three position directional valve 3. In one position 3A the flow bypasses the membrane 4. In other position 3B, the flow is directed to membrane side 4A and in the final position 3C the flow is directed to membrane side 4B.

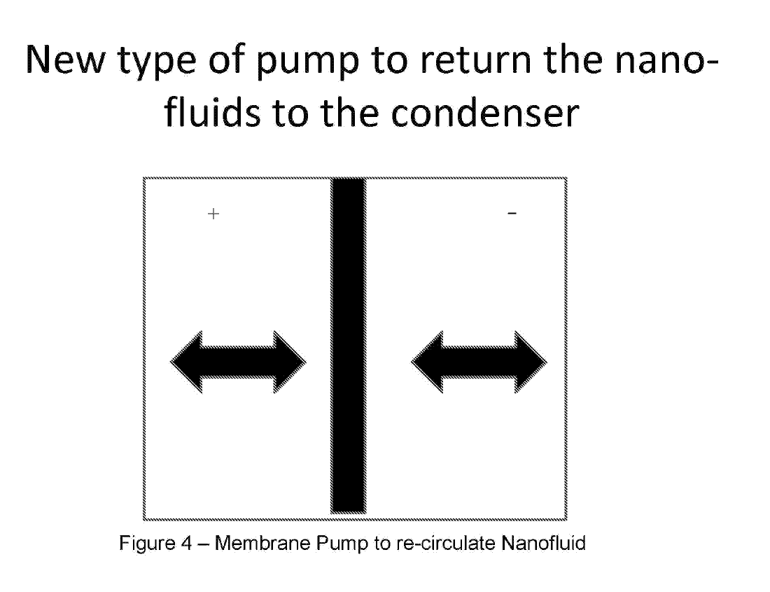

In FIG. 4 the re-circulation pump 8 is depicted. The re-circulation pump 8 can be a positive displacement vane or piston pump. The pump could also be a centrifugal pump. A diaphragm pump could also be used and it is depicted in FIG. 4 where a ionic fluid is used to be transported by a charge through a diaphragm (e.g. naphon). The fluid's direction is controlled by the voltage being applied. The ionic fluid then could push against a diagram (not shown) so the fluid would be pumped or pass through a turbine that is connected to a pump.

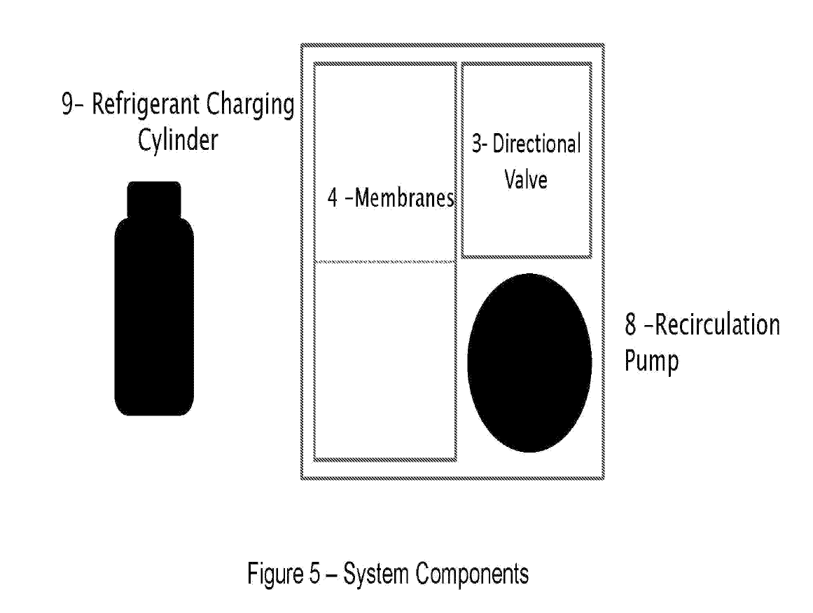

FIG. 5 illustrates a charging cylinder 9. The charging cylinder 9 is evacuated by a vacuum pump (not shown). The nanoparticles are then added to the cylinder. The refrigerant is then pumped down into the charging cylinder 9 where the nanoparticles and the refrigerate are mixed. Acoustic agitation maybe added. The mixture of refrigerant and nanoparticles are then allowed to be charged back into the system. High side charging (discharge of the compressor 7) is used. In the preferred embodiment the membrane 4, direction valve 3 and the re-circulation pump 8 are all located together.

The refrigerant includes any fluorocarbons, especially chlorofluorocarbons, ammonia, sulfur dioxide, water, and any non-halogenated hydrocarbons such as methane.

The membrane in the preferred embodiment is a polymer electrolyte membrane with a pore size of 45 nm. Larger pore sizes can also be used.

The specification details embodiments of the invention. Other embodiments that are equivalent are also claimed.

Having thus described the preferred embodiment, the invention is now claimed to be:

1. A means for increasing the heat transfer of a vapor compression system by increasing the thermal heat transfer properties of the refrigerant by using nanoparticles in the refrigerant and collecting the said nanoparticles at the outlet of the condenser and returning said nanoparticles to the inlet of the condenser.

2. A process for transferring heat in the condenser of a vapor compression system, the method comprising:
transferring heat from the refrigerant with nanoparticles dispersed in the said refrigerant to the metal walls of the condenser to the colder fluid which is a gas or liquid on the outside of the said metal walls of the said condenser where a membrane or filter located at the outlet of the said condenser collects the nanoparticles so that a re-circulating pump can re-circulate the said nanoparticles are returned the said nanoparticles back to the inlet of the said condenser thereby re-circulating the said nanoparticles in the said condenser.

3. The process of claim 2, where the nanoparticles may be either TiO₂, Al₂O₃, CuO, Fe₃O₄, carbon nanotubes single wall, multi-wall carbon nanotubes, graphene, gold nanoparticles or a combination of the above nanoparticles.

4. The process of claim 3, where the nanoparticles are dispersed in the refrigerant by the use of a coating on the nanoparticles or by using a dispersant that produces a stable solution.

5. The process is claim 2 where the nanoparticles have a diameter in the range of 1 nm to 100 nm and a length in the range of 10 nm to 1000 nm.

6. A process for transferring heat in a vapor compression system, the method comprising:
transferring heat from the refrigerant and lubricating oil mixture where nanoparticles are dispersed in said lubricating oil to the metal walls of the condenser to the colder fluid which is a gas or liquid on the outside of the said metal walls of the said condenser where the said nanoparticles are added to the said lubrication oil, where the said lubricating oil is designed to travel through the condenser, expansion valve or capillary tube, evaporator and back to the compressor of the said system.

7. A heat transfer system that re-circulates nanoparticles around the condenser of a vapor compression system comprising:
a.) a re-circulating pump; and
b) a diverter valve; and
c) a duplex membrane or filter; and
d) nanoparticles dispersed in the refrigerant.

8. The system in claim 7, where the nanoparticles are re-circulated back to the condenser and hit a plate so as to aid in de-bundling the said nanoparticles as the said nanoparticles re-enter the said condenser.
